(19) United States
(12) Patent Application Publication
(10) Pub. No.: US 2014/0118304 A1
(43) Pub. Date: May 1, 2014

(54) TOUCH MODULE AND OPERATION METHOD THEREOF

(71) Applicants: Kun-Rong Chang, Hsin-Chu (TW); Wen-Wei Tsai, Hsin-Chu (TW); Kuo-Yuan Liang, Hsin-Chu (TW)

(72) Inventors: Kun-Rong Chang, Hsin-Chu (TW); Wen-Wei Tsai, Hsin-Chu (TW); Kuo-Yuan Liang, Hsin-Chu (TW)

(73) Assignee: CORETRONIC CORPORATION, Hsin-Chu (TW)

(21) Appl. No.: 14/047,026

(22) Filed: Oct. 7, 2013

(30) Foreign Application Priority Data
Oct. 31, 2012 (CN) 201210428674.2

(51) Int. Cl. G06F 3/03

(52) U.S. Cl. CPC G06F 3/0325
USPC 345/175

(57) ABSTRACT

The invention provides a touch module and an operation method thereof. The operation method of touch module includes following steps: detecting a touch point; judging whether the touch point is normal touching according to a detected result of the touch point; when the touch point is abnormal touching, reducing the intensity of an infrared laser of the touch module; and when the touch point is normal touching, judging out the position of the touch point. By using the operation method of touch module, it can reduce or avoid the injury of the infrared laser on the vulnerable portions of human body as abnormal touching.

### CROSS REFERENCE TO RELATED APPLICATION

This application claims the priority benefit of China application serial no. 201210428674.2, filed on Oct. 31, 2012. The entirety of the above-mentioned patent application is hereby incorporated by reference herein and made a part of this specification.

### BACKGROUND

1. Field of the Disclosure

The disclosure generally relates to a touch module and an operation method thereof, and more particularly, to a touch module and an operation method involving infrared laser.

2. Description of Related Art

The touch technology has simplified the communication of the man-machine interface, users can use finger touching to manipulate electronic devices and the corresponding operation. The touch panel can be roughly divided into resistive touch panel, capacitive touch panel, optical touch panel, acoustic wave touch panel and electromagnetic touch panel. Since the touch mechanism of the optical touch panel is suitable for application in a large size display panel, therefore, for the large-size display panel, the touching function thereof is mostly achieved through the optical touch mechanism.

In terms of the optical scanning touch technology, the main elements thereof include light sources, micro electro mechanical system (MEMS) scanning mirrors, a photosensitive IC and a photosensitive semiconductor array. The light emitted by the light sources will enter into a sensing region by means of reflections of two MEMS scanning mirrors disposed at two adjacent corners of the sensing region, and the light provided by the light sources will cover the entire sensing region by means of swinging of the MEMS scanning mirrors. Thus, when a finger or a pen enters the sensing region, scattering light is produced and is received by the photosensitive semiconductor array disposed at the edge of the sensing region. When the photosensitive semiconductor array receives the scattering light, the touching position of the finger or the pen can be calculated according to the instant angles of the MEMS scanning mirrors.

Since laser has good collimation and smaller focusing spot, some optical touch panels prefer to use the laser light source. However, the laser is disadvantageous to easily cause powerful destruction on the retina of the human eye and skin. Therefore, the International Laser Safety Conference has set out safety level requirements for laser consumer products, in which, if the laser energy meets the Class 1 safety level, the laser does not harm the retina of the human eye and the laser is suitable to be applied in the general consumer products.

U.S. Patent Publication No. 20100328243 discloses a MEMS scanning coordinate detection method and a touch panel thereof, wherein the touch panel includes a light source module, a MEMS reflector, an image sensor, an image signal processor, and a coordinate calculator. When the laser light from the light source module is reflected by the MEMS reflector, the laser light is transformed into a scanning light beam. When the touch panel is touched by a pen or a finger, the scanning light beam is blocked and two inactive pixels are formed on the image sensor. The electronic signal is transmitted from the image signal processor and calculated by the coordinate calculator to determine the touch point position.

U.S. Patent Publication No. 20120062517 discloses an optical touch control apparatus and a touch sensing method thereof, in which the optical touch control apparatus includes a light source supply module, an image sensing apparatus and a processing circuit. The light source supply module is used for supplying a light source to illuminate an object located on a plane. The image sensing apparatus is used for detecting the light of the light source reflected by the surface of the object to acquire an image. The processing circuit receives the image and calculates the object position related to the plane according to the image features of the object image in the received image and the imaging position of the object on the image sensing apparatus. In addition, U.S. Pat. No. 5,615,004 discloses a power management system for a laser range finder.

### SUMMARY OF THE DISCLOSURE

Accordingly, the invention is directed to a touch module and an operation method thereof which are able to reduce or avoid injury caused by infrared laser on vulnerable portions of human body (such as eye or infant skin) when abnormal touching.

Other objectives and advantages of the invention may be further comprehended by reading the technical features described in the invention as follows.

To achieve one of, a part of or all of the above-mentioned objectives, or to achieve other objectives, an embodiment of the invention provides a touch module, which includes a photosensitive semiconductor array, a first optical sensor, a second optical sensor and a processing unit. The photosensitive semiconductor array is disposed corresponding to a first edge of a sensing region. The first optical sensor is disposed corresponding to a first corner of the sensing region, in which the first optical sensor includes a first light source, a first micro electro mechanical system (MEMS) scanning mirrors and a first photoreceptor. The first light source is for providing a first infrared laser. The first MEMS scanning mirrors is for reflecting the first infrared laser to enter the sensing region. The first photoreceptor is for sensing whether the angle of reflection of the first infrared laser has reached a returning angle. The second optical sensor is disposed corresponding to a second corner of the sensing region, in which the second optical sensor includes a second light source, a second MEMS scanning mirrors and a second photoreceptor. The second light source is for providing a second infrared laser. The second MEMS scanning mirrors is for reflecting the second infrared laser to enter the sensing region. The second photoreceptor is for sensing whether the angle of reflection of the second infrared laser has reaches the returning angle. The processing unit is coupled to the photosensitive semiconductor array, the first optical sensor and the second optical sensor, in which the processing unit alternately controls the first MEMS scanning mirrors and the second MEMS scanning mirrors for rotating so as to detect a touch point in the sensing region and judges whether the touch point is normal touching according to the detected result of the touch point; when the touch point is abnormal touching, the intensities of the first infrared laser and the second infrared laser are reduced; when the touch point is normal touching, the position of the touch point is judged by the processing unit.

To achieve one of, a part of or all of the above-mentioned objectives, or to achieve other objectives, an embodiment of the invention provides an operation method of touch module, which includes following steps: detecting a touch point; judging whether the touch point is normal touching according to the detected result of the touch point; when the touch point is abnormal touching, reducing the intensity of the infrared laser of the touch module; and when the touch point is normal touching, judging out the position of the touch point.

Based on the description above, in the touch module and the operation method thereof provided by the above-mentioned embodiments of the invention, when the touch point is abnormal touching, the processing unit could reduce the intensities of the first infrared laser and the second infrared laser. In this way, the injury of the infrared laser on the vulnerable portions of human body (such as eye or infant skin) as abnormal touching could be reduced or avoided.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic system diagram of a touch module according to an embodiment of the invention.

FIG. 2 is a schematic system diagram showing an operation method of touch module thereof according to an embodiment of the invention.

FIG. 3 is a schematic system diagram showing an operation method of touch module thereof according to another embodiment of the invention.

FIG. 4 is a schematic system diagram showing an operation method of touch module thereof according to yet another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention could be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

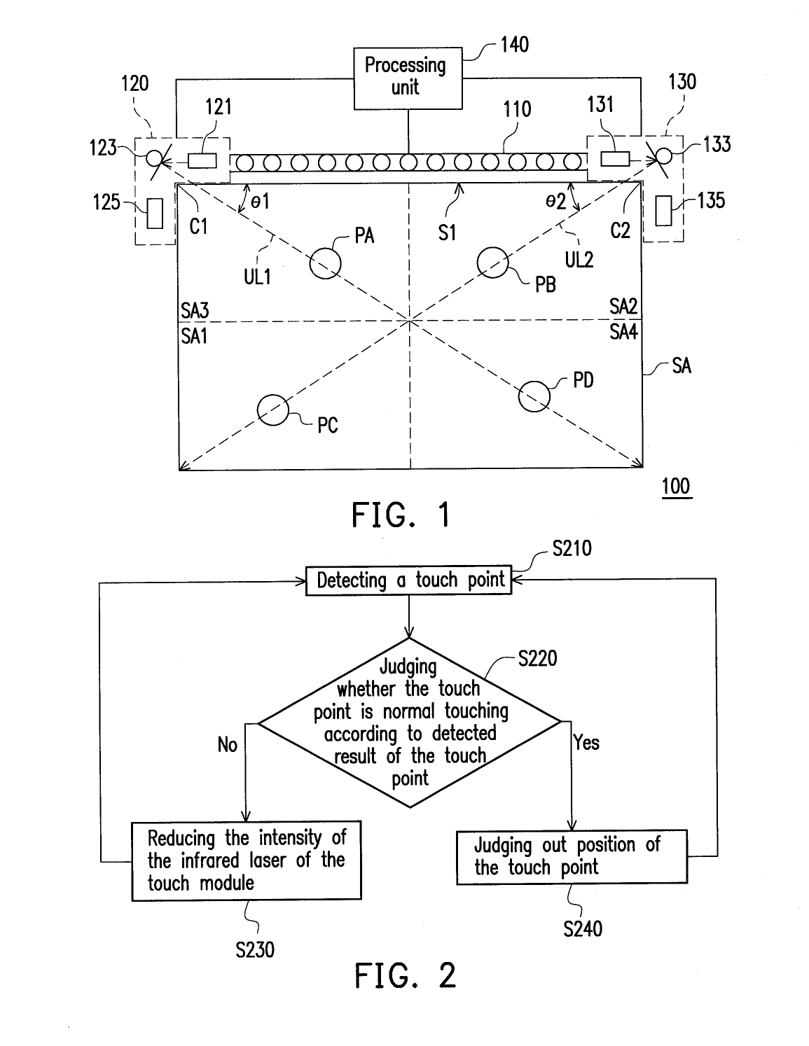

FIG. 1 is a schematic system diagram of a touch module according to an embodiment of the invention. Referring to FIG. 1, in the embodiment, a touch module 100 includes a photosensitive semiconductor array 110, a first optical sensor 120, a second optical sensor 130 and a processing unit 140. The processing unit 140 is coupled to the photosensitive semiconductor array 110, the first optical sensor 120 and the second optical sensor 130. The photosensitive semiconductor array 110 is disposed corresponding to the first edge S1 of a sensing region SA, the first optical sensor 120 is disposed corresponding to the first corner C1 of the sensing region SA and the second optical sensor 130 is disposed corresponding to the second corner C2 of the sensing region SA, in which the first corner C1 and the second corner C2 are located at two sides of the first edge S1.

The first optical sensor 120 includes a first light source 121, a first micro electro mechanical system (MEMS) scanning mirrors 123 and a first photoreceptor 125. The first light source 121 is for providing a first infrared laser UL1. The first MEMS scanning mirrors 123 is for reflecting the first infrared laser UL1 to enter the sensing region SA. The first photoreceptor 125 is for sensing the angle of reflection of the first infrared laser UL1 to judge whether the angle of reflection reaches a returning angle (for example, 90°). The second optical sensor 130 includes a second light source 131, a second MEMS scanning mirrors 133 and a second photoreceptor 135. The second light source 131 is for providing a second infrared laser UL2. The second MEMS scanning mirrors 133 is for reflecting the second infrared laser UL2 to enter the sensing region SA. The second photoreceptor 135 is for sensing the angle of reflection of the second infrared laser UL2 to judge whether the angle of reflection reaches the returning angle (for example, 90°).

In more details, the processing unit 140 controls the first optical sensor 120 to sequentially provide the first infrared laser UL1 with different angles to enter the sensing region SA, controls the second optical sensor 130 to sequentially provide the second infrared laser UL2 with different angles to enter the sensing region SA and senses whether scattered light is produced in the sensing region SA due to touching of an object (for example, hand or pen) by using the photosensitive semiconductor array 110. When the photosensitive semiconductor array 110 does not sense out scattered light, it means no touching object (for example, hand or pen) touches the sensing region SA; when the photosensitive semiconductor array 110 senses out scattered light, it means a touching object (for example, hand or pen) touches the sensing region SA. After that, the processing unit 140 may calculate a position of a touch point (for example, PA-PD) according to the angle of the first infrared laser UL1 (for example, θ1) and the angle of the second infrared laser UL2 (for example, θ2) as the photosensitive semiconductor array 110 senses out scattered light.

In the embodiment, assuming the first light source 121 and the second light source 131 alternately provide the first infrared laser UL1 and the second infrared laser UL2, that is, the first infrared laser UL1 and the second infrared laser UL2 are not simultaneously present. While the first light source 121 is providing the first infrared laser UL1, the processing unit 140 controls the first MEMS scanning mirrors 123 to rotate so as to sequentially provide the first infrared laser UL1 with different angles. When the angle of reflection of the first infrared laser UL1 reaches a returning angle (for example, 90°), the rotation direction of the first MEMS scanning mirrors 123 gets returned to resume to the initial angle of reflection (for example, 0°). While the second light source 131 is providing the second infrared laser UL2, the processing unit 140 controls the second MEMS scanning mirrors 133 to rotate so as to sequentially provide the second infrared laser UL2 with different angles. When the angle of reflection of the second infrared laser UL2 reaches a returning angle (for example, 90°), the rotation direction of the second MEMS scanning mirrors 133 gets returned to resume to the initial angle of reflection (for example, 0°). Thus, the processing unit 140 would alternately controls the first MEMS scanning mirrors 123 and the second MEMS scanning mirrors 133 for rotating to detect a touch point (for example, PA-PD) in the sensing region SA.

In an embodiment of the invention, when the angle of reflection of the first infrared laser UL1 reaches the returning angle (for example, 90°), the processing unit 140 controls the first light source 121 to stop running and controls the second light source 131 to provide the second infrared laser UL2. When the angle of reflection of the second infrared laser UL2 reaches the returning angle (for example, 90°), the processing unit 140 controls the second light source 131 to stop running and controls the first light source 121 to provide the first infrared laser UL1. It can be also that when the angle of reflection of the first infrared laser UL1 resumes to the initial angle of reflection (for example, 0°), the processing unit 140 controls the first light source 121 to stop running and controls the second light source 131 to provide the second infrared laser UL2. When the angle of reflection of the second infrared laser UL2 resumes to the initial angle of reflection (for example, 0°), the processing unit 140 controls the second light source 131 to stop running and controls the first light source 121 to provide the first infrared laser UL1. The above-mentioned description about the operations of the first optical sensor 120 and the second optical sensor 130 are exemplary implementation, which the embodiment of the invention is not limited to.

In general, when a touching object (for example, hand or pen) touches the sensing region SA, the photosensitive semiconductor array 110 would sense out scattering light in a plurality of successive durations (corresponding to a plurality of successive angles of the first infrared laser UL1 and the second infrared laser UL2). At the time, the processing unit 140 is able to calculate a major angle (such as average value) of the first infrared laser UL1 and a major angle (such as average value) of the second infrared laser UL2 to represent the calculation positions respectively through the successive angles of the first infrared laser UL1 and the successive angles of the second infrared laser UL2 (i.e., the detected result of the touch point). The value of the entire successive durations is relative to the size of the touching object (for example, hand or pen), i.e., the entire successive durations is proportional to the width of the touching object.

Thus, the processing unit 140 can judge whether the touch point (such as PA-PD) is normal touching according to the detected result of the touch point (such as PA-PD). When the touch point (such as PA-PD) is normal touching (for example, the case by using hand or pen), the position of the touch point (such as PA-PD) are judged. On contrary, when the touch point (such as PA-PD) is abnormal touching (for example, user's head approaches the sensing region SA), the intensities of the first infrared laser UL1 and the second infrared laser UL2 are reduced (for example, the powers, the energies or the luminance of the first infrared laser UL1 and the second infrared laser UL2 are reduced), in which the intensities of the first infrared laser UL1 and the second infrared laser UL2 could be set as zero (which is equivalent to turning off the first light source 121 and the second light source 131 to cut off the first infrared laser UL1 and the second infrared laser UL2). In this way, it could reduce or avoid the injury of the infrared laser on the vulnerable portions of human body (such as eye or infant skin) during abnormal touching. In addition, to keep the operation of the touch module 100 from the affecting by the above-mentioned turning off, the first light source 121 and the second light source 131 will be restarted after closing by a predetermined duration (such as 900 ms), which the invention is not limited to.

In the embodiment, the size of the touching object could be used to judge whether the touch point (such as PA-PD) is normal touching. When the object width corresponding to the touch point (such as PA-PD) is greater than or equal to 1.5 times of a regular object width (for example, width of hand or pen), the processing unit 140 judges out the touch point (such as PA-PD) is abnormal touching. When the object width corresponding to the touch point (such as PA-PD) is less than 1.5 times of the regular object width, the processing unit 140 judges out the touch point (such as PA-PD) are normal touching. Taking an example, if the entire successive durations corresponding to the regular object width being 8 ms, the entire successive durations corresponding to the object width being over 12 ms could be abnormal touching.

In addition, in an embodiment of the invention, after calculating the positions of the touch point (such as PA-PD), the processing unit 140 adjusts the intensities of the first infrared laser UL1 and the second infrared laser UL2 according to the position of the touch point (such as PA-PD). Referring to FIG. 1, the sensing region SA is divided, for example, into four sub regions SA1-SA4. In other embodiments, the sensing region SA could be divided into more sub regions such as nine or sixteen.

When the touch point is located in the sub region SA3 (for example, the touch point PA), it means that the position of the touch point is close to the first light source 121 but far away from the second light source 131. At this time, the intensity of the first infrared laser UL1 should be reduced and the intensity of the second infrared laser UL2 should be increased (could be set as the maximum intensity). When the touch point is located in the sub region SA2 (for example, the touch point PB), it means that the position of the touch point is far away from the first light source 121 but close to the second light source 131. At this time, the intensity of the first infrared laser UL1 should be increased (could be set as the maximum intensity) and the intensity of the second infrared laser UL2 should be reduced. When the touch point is located in the sub regions SA1 or SA4 (for example, the touch point PC or PD), it means that the position of the touch point is far away from the first light source 121 and the second light source 131. At this time, both the intensities of the first infrared laser UL1 and the second infrared laser UL2 should be increased (could be set as the maximum intensity).

Since the sensing region SA is square or rectangle, the irradiation distances of the first infrared laser UL1 and the second infrared laser UL2 (i.e., the length of the first infrared laser UL1/the second infrared laser UL2 travelling in the first light source 121/the second light source 131 and the sensing region SA) would be varied with different angles of reflection. When the irradiation distances get shorter, the intensities of the first infrared laser UL1 and the second infrared laser UL2 should be reduced; when the irradiation distances get longer, the intensities of the first infrared laser UL1 and the second infrared laser UL2 should be increased.

Therefore, in an embodiment of the invention, the processing unit 140 could adjust the intensity of the first infrared laser UL1 according to the angle of reflection of the first infrared laser UL1 and adjust the intensity of the second infrared laser UL2 according to the angle of reflection of the second infrared laser UL2.

In more details, as shown in FIG. 1, the irradiation distance of the first infrared laser UL1 is the maximum when the angle of reflection is θ1, therefore, the farthest angle of reflection of the first infrared laser UL1 is set as the angle of reflection θ1. When the angle of reflection of the first infrared laser UL1 is far away from the above-mentioned farthest angle of reflection, the processing unit 140 could gradually reduce the intensity of the first infrared laser UL1. When the angle of reflection of the first infrared laser UL1 is close to the above-mentioned farthest angle of reflection, the processing unit 140 could gradually increase the intensity of the first infrared laser UL1.

As shown in FIG. 1, the irradiation distance of the second infrared laser UL2 is the maximum when the angle of reflection is θ2, therefore, the farthest angle of reflection of the second infrared laser UL2 is set as the angle of reflection θ2. When the angle of reflection of the second infrared laser UL2 is far away from the above-mentioned farthest angle of reflection, the processing unit 140 could gradually reduce the intensity of the second infrared laser UL2. When the angle of reflection of the second infrared laser UL2 is close to the above-mentioned farthest angle of reflection, the processing unit 140 could gradually increase the intensity of the second infrared laser UL2.

In addition, the processing unit 140 could take two stages to adjust the intensities of the first infrared laser UL1 and the second infrared laser UL2. When the angles of reflection of the first infrared laser UL1 and the second infrared laser UL2 fall in an angle range containing the farthest angle of reflection (for example, fall in the range of the farthest angle of reflection±10°), the intensities of the first infrared laser UL1 and the second infrared laser UL2 are adjusted to the maximum intensities. When the angles of reflection of the first infrared laser UL1 and the second infrared laser UL2 do not fall in an angle range containing the farthest angle of reflection (for example, do not fall in the range of the farthest angle of reflection±10°), the intensities of the first infrared laser UL1 and the second infrared laser UL2 are adjusted to the lower intensities.

As shown in the embodiment of FIG. 1, during the operation of the touch module 100, the first infrared laser UL1 periodically irradiates onto the first photoreceptor 125, i.e., the angle of reflection of the first infrared laser UL1 periodically reaches the returning angle. In the same way, the second infrared laser UL2 periodically irradiates onto the second photoreceptor 135, i.e., the angle of reflection of the second infrared laser UL2 periodically reaches the returning angle. Thus, when the angle of reflection of one of the first infrared laser UL1 and the second infrared laser UL2 does not periodically reach the returning angle, it means that one of the first MEMS scanning mirrors 123 and the second MEMS scanning mirrors 133 fails to normally run, i.e., the touch module 100 fails to normally sense the touching of the touching object. At this time, the processing unit 140 could shut down the first light source 121 and the second light source 131 and then further shut down the touch module 100. In an embodiment of the invention, the processing unit 140 could send out a warning message to the user to remind that the touch module 100 is not normally operated.

In addition, in an embodiment of the invention, the touch module 100 may detect no touching point (i.e., the touch module 100 is not touched). Under the case of no touching point to be detected, the touch module 100 could gradually reduce the scanning frequency of the sensing region SA, and whenever detecting out the touch point by the touch module 100, the normal scanning frequency of the sensing region SA is resumed (for example, 1 kHz). Or, when the number of scanning operations of the touch module 100 without detecting the touching point reaches a default value (for example, 10 times), the scanning frequency of the sensing region SA could be reduced (for example, 100 Hz), and whenever detecting out the touch point by the touch module 100, the normal scanning frequency of the sensing region SA is resumed (for example, 1 kHz).

FIG. 2 is a schematic system diagram showing an operation method of touch module thereof according to an embodiment of the invention. Referring to FIG. 2, in the embodiment, the steps of the method includes: detecting a touching point first (step S210); judging whether the touching point is normal touching according to the detected result of the touching point after detecting out the touching point (step S220); reducing the intensity of the infrared laser of touch module when the touching point is abnormal touching (step S230), i.e., the judging result of step S220 is “No”; judging out the position of the touching point when the touching point is normal touching (step S240), i.e., the judging result of step S220 is “Yes”, in which after executing step S230 and step S240, the procedure goes back to step S210 to continuously perform the detection of touching points.

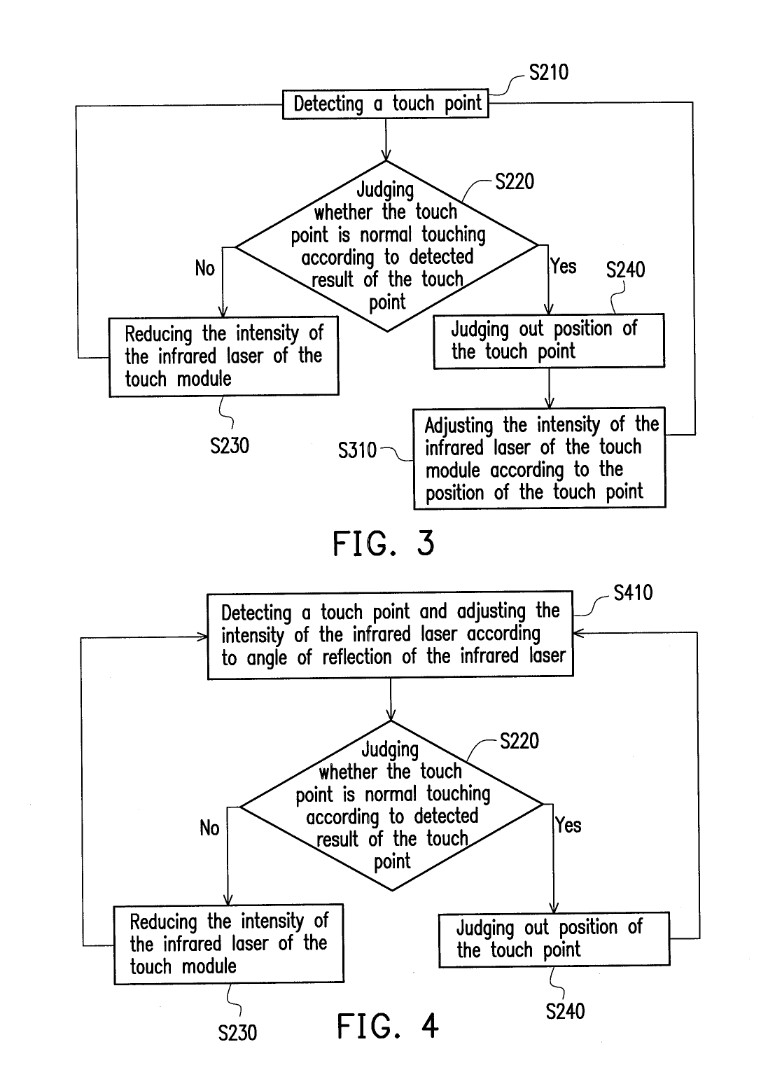

FIG. 3 is a schematic system diagram showing an operation method of touch module thereof according to another embodiment of the invention. Referring to FIGS. 2 and 3, the difference from FIG. 2 rests in that after step S240, the procedure goes to step S310. In step S310, the intensity of the infrared laser of the touch module is adjusted according to the position of the touching point. And, after step S310, the procedure goes back to step S210 to continuously perform the detection of touching points.

FIG. 4 is a schematic system diagram showing an operation method of touch module thereof according to yet another embodiment of the invention. Referring to FIGS. 2 and 4, the difference from FIG. 2 rests in that after step S230 and step S240, the procedure goes to step S410 to continuously perform the detection of touching point. In step S410, the touching point is detected and the intensity of the infrared laser is adjusted according to the angle of reflection of the infrared laser of the touch module.

The step sequence in the embodiments of FIGS. 2-4 is an example only, which the embodiment of the invention is not limited to. The detail of the steps in the embodiments of FIGS. 2-4 could refer to the description of the embodiment of FIG. 1, which is omitted to describe.

In summary, in the touch module and the operation method thereof provided by the above-mentioned embodiments of the invention, when the touch point is abnormal touching, the processing unit could reduce the intensities of the first infrared laser and the second infrared laser. In this way, the injury of the infrared laser on the vulnerable portions of human body (such as eye or infant skin) could be reduced or avoided as abnormal touching. In addition, the processing unit adjusts the intensities of the first infrared laser and the second infrared laser according to the position of the touch point. Or, the processing unit could adjust the intensity of the first infrared laser according to the angle of reflection of the first infrared laser and adjust the intensity of the second infrared laser according to the angle of reflection of the second infrared laser. By this way, the power consumption of the touch module could be reduced without affecting the function thereof.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A touch module, comprising:
a photosensitive semiconductor array, disposed corresponding to a first edge of a sensing region;
a first optical sensor, disposed corresponding to a first corner of the sensing region, wherein the first optical sensor comprises:
a first light source, for providing a first infrared laser;
a first MEMS scanning mirrors for reflecting the first infrared laser to enter the sensing region; and
a first photoreceptor, for sensing whether an angle of reflection of the first infrared laser has reached a returning angle;
a second optical sensor, disposed corresponding to a second corner of the sensing region, wherein the second optical sensor comprises:
a second light source, for providing a second infrared laser;
a second MEMS scanning mirrors, for reflecting the second infrared laser to enter the sensing region; and
a second photoreceptor, for sensing whether an angle of reflection of the second infrared laser has reached the returning angle; and
a processing unit, coupled to the photosensitive semiconductor array, the first optical sensor and the second optical sensor, wherein the processing unit alternately controls the first MEMS scanning mirrors and the second MEMS scanning mirrors for rotating so as to detect a touch point in the sensing region and judge whether the touch point is normal touching according to detected result of the touch point; when the touch point is abnormal touching, intensities of the first infrared laser and the second infrared laser are reduced; when the touch point is normal touching, position of the touch point is judged.

2. The touch module as claimed in claim 1, wherein when the touch point is abnormal touching, the processing unit turns off the first light source and the second light source by a predetermined duration.

3. The touch module as claimed in claim 1, wherein the processing unit adjusts the intensities of the first infrared laser and the second infrared laser according to the position of the touch point.

4. The touch module as claimed in claim 3, wherein when the position of the touch point is close to the first light source, the processing unit reduces the intensity of the first infrared laser; when the position of the touch point is far away from the first light source, the processing unit increases the intensity of the first infrared laser; when the position of the touch point is close to the second light source, the processing unit reduces the intensity of the second infrared laser; when the position of the touch point is far away from the second light source, the processing unit increases the intensity of the second infrared laser.

5. The touch module as claimed in claim 1, wherein the processing unit adjusts the intensity of the first infrared laser according to the angle of reflection of the first infrared laser and adjusts the intensity of the second infrared laser according to the angle of reflection of the second infrared laser.

6. The touch module as claimed in claim 5, wherein when the angle of reflection of the first infrared laser is far away from a farthest angle of reflection, the processing unit reduces the intensity of the first infrared laser; when the angle of reflection of the first infrared laser is close to the farthest angle of reflection, the processing unit increases the intensity of the first infrared laser; when the angle of reflection of the second infrared laser is far away from the farthest angle of reflection, the processing unit reduces the intensity of the second infrared laser; when the angle of reflection of the second infrared laser is close to the farthest angle of reflection, the processing unit increases the intensity of the second infrared laser.

7. The touch module as claimed in claim 1, wherein when the angle of reflection of one of the first infrared laser and the second infrared laser does not periodically reach the returning angle, the processing unit turns off the first light source and the second light source.

8. An operation method of touch module, comprising:
detecting a touch point;
judging whether the touch point is normal touching according to a detected result of the touch point;
when the touch point is abnormal touching, reducing the intensity of an infrared laser of the touch module; and
when the touch point is normal touching, judging out a position of the touch point.

9. The operation method of touch module as claimed in claim 8, wherein the step of reducing the intensity of the infrared laser of the touch module comprises:
cutting off the infrared laser of the touch module by a predetermined duration.

10. The operation method of touch module as claimed in claim 8, further comprising:
adjusting the intensity of the infrared laser according to the position of the touch point.

11. The operation method of touch module as claimed in claim 10, wherein the step of adjusting the intensity of the infrared laser according to the position of the touch point comprises:
when the position of the touch point is close to the light source of providing the infrared laser, reducing the intensity of the infrared laser; and
when the position of the touch point is far away from the light source, increasing the intensity of the infrared laser.

12. The operation method of touch module as claimed in claim 8, further comprising:
adjusting the intensity of the infrared laser according to angle of reflection of the infrared laser.

13. The operation method of touch module as claimed in claim 12, wherein the step of adjusting the intensity of the infrared laser according to the angle of reflection of the infrared laser comprises:
when the angle of reflection of the infrared laser is far away from a farthest angle of reflection, reducing the intensity of the infrared laser; and
when the angle of reflection of the infrared laser is close to the farthest angle of reflection, increasing the intensity of the infrared laser.

14. The operation method of touch module as claimed in claim 12, further comprising:
when the angle of reflection of the infrared laser does not periodically reach a returning angle, turning off the infrared laser of the touch module.
